(19) United States
(12) Patent Application Publication
(10) Pub. No.: US 2026/0220020 A1
(43) Pub. Date: Jul. 30, 2026

(54) CODE DETECTION METHOD, APPARATUS, DEVICE, MEDIUM, AND PRODUCT

(71) Applicant: Beijing Volcano Engine Technology Co., Ltd., Beijing (CN)

(72) Inventors: Jun MA, Beijing (CN); Yuefeng LI, Beijing (CN)

(21) Appl. No.: 19/337,793

(22) Filed: Sep. 23, 2025

(30) Foreign Application Priority Data
Jan. 27, 2025 (CN) 202510128138.8

(51) Int. Cl. G06F 11/3604

(52) U.S. Cl. CPC G06F 11/3604

(57) ABSTRACT

The present application provides a code detection method and apparatus, a device, a medium, and a product. The method includes: obtaining first code; performing tokenization on the first code to obtain a plurality of tokens; and inputting the plurality of tokens into a Mixture-of-Experts model, and receiving a code detection result output by the Mixture-of-Experts model, wherein the Mixture-of-Experts model includes a first expert model configured to extract a feature related to a first-type attack, a second expert model configured to extract a feature related to obfuscated code, and a third expert model configured to extract a feature related to language model-generated code, the code detection result is determined based on at least one consisting of: the feature related to the first-type attack, the feature related to the obfuscated code, and the feature related to the language model-generated code.

### CROSS-REFERENCE TO RELATED APPLICATION

This application claims priority to Chinese Patent Application No. 202510128138.8, filed on Jan. 27, 2025, which is incorporated herein by reference in its entirety as a part of this application.

### TECHNICAL FIELD

The present application relates to the technical field of computers, and in particular, to a code detection method, an apparatus, an electronic device, a computer-readable storage medium, and a computer program product.

### BACKGROUND

With the continuous development of computer technologies, security protection products for security detection have been created at the right moment. The security protection product may perform detection on a physical computing device, such as a computer or a host, or a virtual computing device, such as a container, thereby ensuring the operation security.

The security protection product may perform various detections on the computing device. In order to avoid detection of an attack behavior by the security protection product, an attacker usually uses an obfuscation technique to process code used for performing an attack, to obtain attack obfuscated code, and perform an obfuscation attack.

In the related art, a language model is used to generate a large amount of attack-obfuscated code. How to detect the attack-obfuscated code generated by the language model and improve the protection capability of the security protection product has become an urgent problem to be solved.

### SUMMARY

The present application provides a code detection method. The present application further provides an apparatus, an electronic device, a computer-readable storage medium, and a computer program product that correspond to the foregoing method.

According to a first aspect, the present application provides a code detection method. The method includes:
obtaining first code;
performing tokenization on the first code to obtain a plurality of tokens; and
inputting the plurality of tokens into a Mixture-of-Experts model, and receiving a code detection result output by the Mixture-of-Experts model, where the Mixture-of-Experts model includes a first expert model configured to extract a feature related to a first-type attack, a second expert model configured to extract a feature related to obfuscated code, and a third expert model configured to extract a feature related to language model-generated code, the code detection result is determined based on one or more of the feature related to the first-type attack, the feature related to the obfuscated code, and the feature related to the language model-generated code, and the code detection result is used to represent whether the first code belongs to obfuscated code that is generated by a language model and used to perform the first-type attack.

According to a second aspect, the present application provides a code detection apparatus. The apparatus includes:
an obtaining module configured to obtain first code;
a tokenization module configured to perform tokenization on the first code to obtain a plurality of tokens; and
a detection module configured to input the plurality of tokens into a Mixture-of-Experts model, and receive a code detection result output by the Mixture-of-Experts model, where the Mixture-of-Experts model includes a first expert model configured to extract a feature related to a first-type attack, a second expert model configured to extract a feature related to obfuscated code, and a third expert model configured to extract a feature related to language model-generated code, the code detection result is determined based on one or more of the feature related to the first-type attack, the feature related to the obfuscated code, and the feature related to the language model-generated code, and the code detection result is used to represent whether the first code belongs to obfuscated code that is generated by a language model and used to perform the first-type attack.

According to a third aspect, the present application provides an electronic device. The electronic device includes a processor and a memory. The processor and the memory communicate with each other. The processor is configured to execute instructions stored in the memory, to enable the electronic device to perform the code detection method according to the first aspect or any implementation of the first aspect.

According to a fourth aspect, the present application provides a computer-readable storage medium. The computer-readable storage medium stores instructions, and the instructions instruct an electronic device to perform the code detection method according to the first aspect or any implementation of the first aspect.

According to a fifth aspect, the present application provides a computer program product including instructions. When the computer program product runs on an electronic device, the electronic device is enabled to perform the code detection method according to the first aspect or any implementation of the first aspect.

In the present application, based on the implementations provided in the foregoing aspects, further combination may be performed to provide more implementations.

### BRIEF DESCRIPTION OF DRAWINGS

In order to more clearly describe the technical methods in embodiments of the present application, the following briefly describes the drawings used in describing the embodiments.

FIG. 1 is a schematic flowchart of a code detection method according to an embodiment of the present application;

FIG. 2 is a schematic diagram of a structure of a Mixture-of-Experts model according to an embodiment of the present application;

FIG. 3 is a schematic diagram of a training process of a Mixture-of-Experts model according to an embodiment of the present application;

FIG. 4 is a schematic diagram of a structure of a code detection apparatus according to an embodiment of the present application; and

FIG. 5 is a schematic diagram of a structure of an electronic device according to an embodiment of the present application.

### DETAILED DESCRIPTION

The terms “first” and “second” in the embodiments of the present application are used for descriptive purposes only, and cannot be understood as indicating or implying relative importance or implicitly indicating the number of indicated technical features. Therefore, the features defined as “first” and “second” may explicitly or implicitly include one or more features.

Some technical terms and application scenarios involved in embodiments of the present application are first described.

With the continuous development of computer technologies, security protection products for performing security detection to ensure the security of physical computing devices, such as computers and hosts, or virtual computing devices, such as containers, have been created at the right moment. The security protection product may perform various security detections for a plurality of operating scenarios. For example, the security protection product may be a cloud workload protection platform (CWPP), and the CWPP may perform detection on host security and network security. For another example, the security protection product may be a host-based intrusion detection system (HIDS), and the HIDS may perform security detection on the behavior and status of a computer system. For still another example, the security protection product may be cloud security posture management (CSPM), and the CSPM may evaluate and manage cloud security risks, identify configuration errors, and security vulnerabilities in a cloud environment.

In some examples, the security protection product may perform detection on a command execution environment (webshell) attack. A webshell is a code execution environment that exists in the form of a web page file, such as an asp, a php, a jsp, or a cgi, and is used to perform operations such as website management, server management, and permission management.

In a webshell attack, an attacker executes a command on a target server through the webshell to get control over the target server. Specifically, the attacker uploads code used for performing the webshell attack to the target server, accesses a webshell page through a browser, inputs a to-be-executed command in a command input box of the webshell page, to control the target server.

In the related art, a security protection product usually detects code used for performing a webshell attack at the level of a static file. For example, the security protection product may match a webshell pattern through a yara rule, such as a specific character string, a function call, and a code structure. For another example, the security protection product may also match a webshell feature through a regular expression, such as a specific keyword (eval, exec, system, or the like).

In order to avoid detection of a webshell attack by a security protection product, an attacker usually uses an obfuscation technique to process code used for performing the webshell attack, to obtain webshell attack-obfuscated code, and perform an obfuscation-type webshell attack. In addition, the attacker may also use a language model to generate a large amount of webshell attack-obfuscated code, and the webshell attack obfuscated code generated by the language model may achieve anti-detection, that is, the webshell attack obfuscated code generated by the language model may bypass the detection by the security protection product.

In view of this, the present application provides a code detection method. In the method, obtaining first code firstly, and performing tokenization on the first code to obtain a plurality of tokens; and then inputting the plurality of tokens into a Mixture-of-Experts model, and receiving a code detection result output by the Mixture-of-Experts model, where the Mixture-of-Experts model includes a first expert model configured to extract a feature related to a first-type attack, a second expert model configured to extract a feature related to obfuscated code, and a third expert model configured to extract a feature related to language model-generated code, the code detection result is determined based on one or more of the feature related to the first-type attack, the feature related to the obfuscated code, and the feature related to the language model-generated code, and the code detection result is used to represent whether the first code belongs to obfuscated code that is generated by a language model and used to perform the first-type attack.

In the method, the Mixture-of-Experts model is used for code detection. The three expert models in the Mixture-of-Experts model respectively detect whether the code is used to perform the first-type attack, whether the code belongs to the obfuscated code, and whether the code is generated by the language model. Different features are considered comprehensively, to effectively and comprehensively identify whether the code is attack obfuscated code generated by the language model, thereby improving the protection performance of the security protection product against an attack behavior, and reducing the risk of false reports and missed reports.

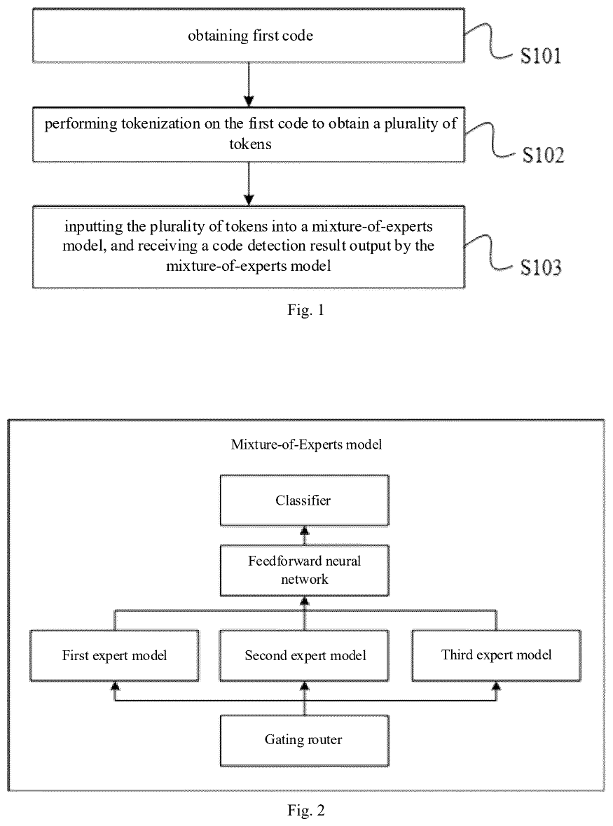

To facilitate understanding of the technical solutions provided in the embodiments of the present application, the following describes with reference to the drawings. FIG. 1 is a schematic flowchart of a code detection method. The method specifically includes the following steps.

S101: obtaining first code.

The first code may be understood as to-be-detected code. In other words, there is a detection requirement on whether the first code is obfuscated code that is generated by a language model and used to perform a specific type of attack (for example, a webshell attack). For example, the first code may be a code character string in a format such as an asp, a php, a jsp, or a cgi.

S102: performing tokenization on the first code to obtain a plurality of tokens.

In the embodiment of the present application, tokenization may be understood as a process of decomposing the first code into a series of meaningful units, and one meaningful unit may be referred to as a token (token). In the subsequent code detection process, detection is performed in the unit of token, which helps improve the detection efficiency and detection accuracy.

During specific implementation, the process of performing tokenization on the first code may be implemented by any tokenizer. The first code is input into the tokenizer, to obtain a plurality of tokens output by the tokenizer.

S103: inputting the plurality of tokens into a Mixture-of-Experts model, and receiving a code detection result output by the Mixture-of-Experts model.

A mixture of experts (MoE) model is an efficient deep learning architecture. By decomposing an original task into a plurality of subtasks, different expert models are used to process the different subtasks. In this way, each expert model may focus on a specific subtask, which helps improve the generalization capability and inference performance of the Mixture-of-Experts model.

In the embodiment of the present application, the Mixture-of-Experts model includes a first expert model configured to extract a feature related to a first-type attack, a second expert model configured to extract a feature related to obfuscated code, and a third expert model configured to extract a feature related to language model-generated code.

It should be noted that the first-type attack is not limited in the embodiment of the present application. For example, the first-type attack may be a webshell attack, or the first-type attack may be another arbitrary type of attack.

The language model has a natural language processing capability, and may understand the meaning of a natural language and process different types of natural language tasks. For example, the language model may be a deep learning model trained using a code sample.

That is, in the embodiment of the present application, the original task is “detecting whether the first code is obfuscated code that is generated by a language model and used to perform the first-type attack”. Because there is a difference between code generated by the language model and manually written code, for example, content generated by the language model often has a consistent naming rule, a consistent comment style, and a templated code structure, the original task is decomposed into three subtasks: “detecting whether the first code is used to perform the first-type attack”, “detecting whether the first code is obfuscated code”, and “detecting whether the first code is generated by the language model”.

The three expert models are respectively used to perform the above three subtasks, to extract one or more of the feature related to the first-type attack, the feature related to the obfuscated code, and the feature related to the language model-generated code in each token. In other words, the Mixture-of-Experts model performs processing of a plurality of subtasks for each token, to identify whether there is one or more of the following items in each token of the first code: a feature representing that the first code is used to perform the first-type attack, a feature representing that the first code belongs to the obfuscated code, and a language model generation trace; and then determine the code detection result of the first code based on one or more of the feature related to the first-type attack, the feature related to the obfuscated code, and the feature related to the language model-generated code (for example, consistent syntax, code structure, naming rule, comment style, and the like), where the code detection result may be used to represent whether the first code belongs to the obfuscated code that is generated by the language model and used to perform the first-type attack, thereby improving the accuracy and robustness of code detection. The accuracy of code detection is improved through collaborative processing of a plurality of expert models.

The types of the first expert model, the second expert model, and the third expert model are not limited in the embodiment of the present application. For example, the first expert model, the second expert model, and the third expert model may be language models having a natural language processing capability. For another example, the first expert model, the second expert model, and the third expert model may be another models having a code recognition capability.

In the Mixture-of-Experts model, each token may be processed by one or more expert models. Specifically, referring to FIG. 2, which is a schematic diagram of the structure of a Mixture-of-Experts model, the Mixture-of-Experts model may further include a gating router, and outputs of the gating router are respectively inputs of the first expert model, the second expert model, and the third expert model.

The gating router, which may also be referred to as a gating network, a router, a gating control network, or the like, may be implemented based on a neural network. In the embodiment of the present application, the gating router may be configured to receive each token of the first code, and allocate each token to one or more expert models in the Mixture-of-Experts model, that is, determine an expert model that needs to be activated for each token.

During specific implementation, the following operation is performed for each of the plurality of tokens: inputting the token into the gating router, such that the gating router determines an expert model activation probability of the token, sending the token to a target expert model corresponding to the expert model activation probability, and obtains a target sub-feature of the token that is returned by the target expert model. Then, the code detection result is determined based on the target sub-feature of each token.

The target expert model is one or more of the first expert model, the second expert model, and the third expert model. The target sub-feature is one or more of the feature related to the first-type attack, the feature related to the obfuscated code, and the feature related to the language model-generated code.

In other words, the gating router extracts a feature of the token, and based on the feature of the token, determines which expert model or expert models should process the token, and generates an expert model activation probability (for example, weight distribution) of the token. The expert model activation probability may be used to represent a probability that each expert model is activated. In this way, the gating router determines, based on the expert model activation probability of the token, the target expert model for processing the token, and then sends the token to the target expert model, such that the target expert model performs feature extraction on the token, to obtain the target sub-feature of the token.

In some embodiments, the gating router may activate all the expert models whose activation probability indicated by the expert model activation probability is not 0, that is, the target expert model corresponding to the expert model activation probability is an expert model whose activation probability is not 0. For example, if the expert model activation probability is that the activation probability of the first expert model is 0.5, the activation probability of the second expert model is 0.2, and the activation probability of the third expert model is 0.3, the target expert models corresponding to the expert model activation probability are the first expert model, the second expert model, and the third expert model. If the expert model activation probability is that the activation probability of the first expert model is 0.7, the activation probability of the second expert model is 0, and the activation probability of the third expert model is 0.3, the target expert models corresponding to the expert model activation probability are the first expert model and the third expert model.

In some other embodiments, the gating router may also perform sparse activation, and only activate some expert models, to reduce the calculation overhead. For example, the target expert model corresponding to the expert model activation probability is an expert model selected through Top-K selection or Top-P selection. For example, in the Top-K selection, K=2, the expert model activation probability is that the activation probability of the first expert model is 0.5, the activation probability of the second expert model is 0.2, and the activation probability of the third expert model is 0.3. After sorting is performed in a descending order of the activation probability, because the activation probability of the first expert model and the activation probability of the third expert model rank in the top two, the target expert models corresponding to the expert model activation probability are the first expert model and the third expert model. In the Top-P selection, P=0.6, the expert model activation probability is that the activation probability of the first expert model is 0.55, the activation probability of the second expert model is 0.25, and the activation probability of the third expert model is 0.2. After sorting is performed in a descending order of the activation probability, because the sum of the activation probability of the first expert model and the activation probability of the second expert model is greater than 0.6, the target expert models corresponding to the expert model activation probability are the first expert model and the second expert model.

In this way, the gating router in the Mixture-of-Experts model sends different parts (that is, different tokens) in the first code to the expert models adapted to the tokens for processing, to obtain the target sub-feature of each token, thereby improving the efficiency and performance of the Mixture-of-Experts model.

Further, still referring to FIG. 2, the Mixture-of-Experts model may further include a feedforward neural network and a classifier. An input of the feedforward neural network is an output of the first expert model, an output of the second expert model, and an output of the third expert model, and an input of the classifier is an output of the feedforward neural network.

In the embodiment of the present application, the feedforward neural network may be configured to fuse the target sub-feature of each token, and the classifier may be configured to classify the first code based on a fused feature of each token, and output the code detection result of the first code.

During specific implementation, the following operation is performed for the target sub-feature of each token: sending the target sub-feature of the token to the feedforward neural network, such that the feedforward neural network fuses, based on the expert model activation probability of the token, the target sub-feature of the token to obtain a target feature of the token. Then, the target feature of each token is sent to the classifier, to obtain the code detection result output by the classifier.

Because the expert model activation probability of the token may be used to represent the probability that each expert model is activated, during the feature fusion process in the feedforward neural network, the target sub-feature extracted by each target expert model may be fused according to the activation probability indicated by the expert model activation probability, to obtain the target feature of the token. For example, the expert model activation probability is that the activation probability of the first expert model is 0.5, the activation probability of the second expert model is 0.2, and the activation probability of the third expert model is 0.3; the target expert models corresponding to the expert model activation probability are the first expert model and the third expert model; the target sub-feature of the token is the feature related to the first-type attack extracted by the first expert model and the feature related to the language model-generated code extracted by the third expert model; and the feedforward neural network may perform feature fusion on the feature related to the first-type attack and the feature related to the language model-generated code at a ratio of 5:3, to obtain the target feature of the token.

After the feedforward neural network completes feature fusion of each token of the first code, the classifier may classify the first code based on the target feature of each token, to identify whether the first code belongs to the obfuscated code that is generated by the language model and used to perform the first-type attack.

After completing the detection of the first code, the code detection result may also be presented to the user. In some possible implementations, a disposal suggestion for the first code is generated in response to the code detection result representing that the first code belongs to the obfuscated code that is generated by the language model and used to perform the first-type attack. The disposal suggestion may include at least one of the following: a code obfuscation manner of the first code, and code content generated by the language model in the first code.

In other words, when the first code is the obfuscated code that is generated by the language model and used to perform the first-type attack, the code obfuscation manner and the language model generation trace in the first code are presented to the user together, to help the user understand the code detection result, to quickly and accurately respond.

In the method, the Mixture-of-Experts model is used for code detection. The three expert models in the Mixture-of-Experts model respectively detect whether the code is used to perform the first-type attack, whether the code belongs to the obfuscated code, and whether the code is generated by the language model. Different features are considered comprehensively, to effectively and comprehensively identify whether the code is attack-obfuscated code generated by the language model, thereby improving the protection performance of the security protection product against an attack behavior and reducing the risk of false reports and missed reports.

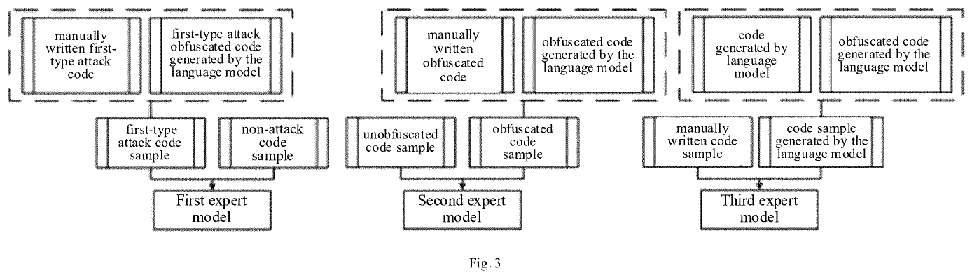

The code detection method provided in the embodiments of the present application is described above. In the embodiments of the present application, the first code is detected by using the Mixture-of-Experts model. With reference to FIG. 3 which is a schematic diagram of a training process of a Mixture-of-Experts model, the following describes the training process of the Mixture-of-Experts model.

In some possible implementations, the Mixture-of-Experts model may be trained by: obtaining a non-attack code sample and a first-type attack code sample, using the non-attack code sample as a negative sample and the first-type attack code sample as a positive sample, and training a first pre-trained model to obtain the first expert model; obtaining an unobfuscated code sample and an obfuscated code sample, using the unobfuscated code sample as a negative sample and the obfuscated code sample as a positive sample, and training a second pre-trained model to obtain the second expert model; and obtaining a manually written code sample and a language model-generated code sample, using the manually written code sample as a negative sample and the language model-generated code sample as a positive sample, and training a third pre-trained model to obtain the third expert model.

The first pre-trained model, the second pre-trained model, and the third pre-trained model may be pre-trained language models. In other words, in the embodiment of the present application, fine-tuning is performed based on the first pre-trained model, the second pre-trained model, and the third pre-trained model, such that the fine-tuned first expert model has a capability of extracting the feature related to the first-type attack and detecting whether the first code is used for the first-type attack, the fine-tuned second expert model has a capability of extracting the feature related to the obfuscated code and detecting whether the first code is the obfuscated code, and the fine-tuned third expert model has a capability of extracting the feature related to the language model-generated code and detecting whether the first code is generated by the language model.

During specific implementation, the first pre-trained model, the second pre-trained model, and the third pre-trained model are trained in a supervised training manner, to generate the first expert model, the second expert model, and the third expert model. In supervised training, labeled training data is used for model training. In the embodiment of the present application, the label may be understood as a positive sample or a negative sample, that is, for the positive sample, the trained model should output a positive classification result, and for the negative sample, the trained model should output a negative classification result.

It should be noted that, in the embodiment of the present application, in the training stage of the Mixture-of-Experts model, in order to better enable the first expert model, the second expert model, and the third expert model to focus on feature extraction, and improve the generalization capability of the first expert model, the second expert model, and the third expert model, a classifier may be externally connected after the first pre-trained model, the second pre-trained model, and the third pre-trained model.

Specifically, in the training stage of the first expert model, a first classifier is externally connected after the first pre-trained model. The first classifier may be configured to classify the feature extracted by the first pre-trained model, to obtain a first classification result representing whether the first code is used to perform the first-type attack; and then calculate a cross-entropy loss based on the label, to train the first pre-trained model to obtain the first expert model. In the training stage of the second expert model, a second classifier is externally connected after the second pre-trained model. The second classifier may be configured to classify the feature extracted by the second pre-trained model, to obtain a second classification result representing whether the first code is the obfuscated code; and then calculate a cross-entropy loss based on the label, to train the second pre-trained model to obtain the second expert model. In the training stage of the third expert model, a third classifier is externally connected after the third pre-trained model. The third classifier may be configured to classify the feature extracted by the third pre-trained model, to obtain a third classification result representing whether the first code is generated by the language model; and then calculate a cross-entropy loss based on the label, to train the third pre-trained model to obtain the third expert model.

In the inference stage of the Mixture-of-Experts model, there is no need to externally connect a classifier after the first expert model, the second expert model, and the third expert model, and the first expert model, the second expert model, and the third expert model only need to extract the feature of the token.

Still referring to FIG. 3, the non-attack code sample may be understood as code that is not used to perform the first-type attack. In some embodiments, the first-type attack is a webshell attack, and the non-attack code sample may be code in a format such as an asp, a php, a jsp, or a cgi that is not used to perform the webshell attack. The first-type attack code sample may be understood as code used to perform the webshell attack. In some embodiments, the first-type attack code sample may include at least one of the following: manually written first-type attack code and first-type attack obfuscated code generated by a language model.

The unobfuscated code sample may be understood as code in which there is no code obfuscation, and the obfuscated code sample may be understood as code in which there is code obfuscation. In some embodiments, the obfuscated code sample may include at least one of the following: manually written obfuscated code and obfuscated code generated by a language model.

The manually written code sample may be understood as code written manually (for example, by a developer), and the language model-generated code sample may be understood as code that is automatically generated by the language model and has a language model generation trace. In some embodiments, the language model-generated code sample may include at least one of the following: obfuscated code generated by the language model and code generated by the language model.

In some possible implementations, the first-type attack obfuscated code generated by the language model and the obfuscated code generated by the language model are generated by: obtaining first obfuscated code, second obfuscated code, first unobfuscated code, and second unobfuscated code, using a first language model to perform code obfuscation manner extraction on the first obfuscated code and the second obfuscated code to obtain at least one code obfuscation manner, and then using a second language model to perform code obfuscation on the first unobfuscated code and the second unobfuscated code based on the at least one code obfuscation manner, to obtain the first-type attack obfuscated code generated by the language model and the obfuscated code generated by the language model.

The first obfuscated code is obfuscated code used to perform the first-type attack, the second obfuscated code is obfuscated code irrelevant to the first-type attack, the first unobfuscated code is unobfuscated code used to perform the first-type attack, and the second unobfuscated code is unobfuscated code irrelevant to the first-type attack.

In other words, a code obfuscation manner is extracted from the obfuscated code used to perform the first-type attack and the obfuscated code irrelevant to the first-type attack, and the extracted code obfuscation manner is used as a template to perform code obfuscation on the unobfuscated code used to perform the first-type attack and the unobfuscated code irrelevant to the first-type attack, to generate a large amount of obfuscated code generated by the language model, thereby implementing data enhancement and improving the training effect.

The code obfuscation manner may be understood as a manner used to obfuscate the code. In some embodiments, the code obfuscation manner may include at least one of the following: a manner of using a bitwise operator to operate on a character string in the code, a manner of concatenating or splitting a character string in the code, a manner of using a random variable name in the code, a manner of obfuscating an input parameter and an output parameter of a function call in the code, and a manner of obfuscating a conditional judgment statement in the code.

In the manner of using the bitwise operator to operate on the character string in the code, the bitwise operator (such as “&”, “|”, or “\hat{ }”) is used to operate on the character string in the code, such that the code becomes difficult to understand. For example, the obfuscated code may be “<?php $var1=‘string1’ & ‘string2’; $var2=‘string3’|‘string4’; $var3=‘string5’\hat{ }‘string6’; ?>”. In the manner of concatenating or splitting the character string in the code, the content of the character string in the code is hidden by concatenating or splitting the character string. For example, the obfuscated code may be “<?php $var4=‘part1’. ‘part2’. ‘part3’; $var5=‘part4’ & ‘part5’; ?>”. In the manner of using the random variable name in the code, a random and meaningless variable name is used, such that the code is difficult to read and understand. For example, the obfuscated code may be “<?php $complexVar1=‘value1’; $complexVar2=‘value2’; ?>”. In the manner of obfuscating the input parameter and the output parameter of the function call in the code, the parameter and the return value of the function call in the code are obfuscated, such that the code logic is difficult to identify. For example, the obfuscated code may be “<?php if (function1($param1($param2))==$expectedValue) {$result=function2($param3, param1($param4. $param5. $param6)); $result($param7, $param8, $param9);}?>”. In the manner of obfuscating the conditional judgment statement in the code, the execution path of the code is difficult to predict through complex condition judgment. For example, the obfuscated code may be “<?php if ($condition1($param1($param2))==$expectedValue) {//Execute the code}?>”

In the embodiment of the present application, a language model is used to extract a code obfuscation manner and perform code obfuscation. The first language model may be understood as a language model used to extract the code obfuscation manner, and the second language model may be understood as a language model used to perform code obfuscation. The first language model and the second language model have a natural language processing capability, and may understand the meaning of a natural language and process different types of natural language tasks. For example, the first language model and the second language model may be deep learning models trained using text data.

The first language model may perform code obfuscation manner extraction on the first obfuscated code and the second obfuscated code in a prompt learning-based manner. A prompt may be used to guide the language model to perform specific output in a generative task (for example, a text generation task, a question answering task, or a dialogue task). The prompt is configured to help the language model understand the background and requirements of the task, such that the language model may process different types of natural language processing tasks without retraining the language model, thereby increasing the expandability and flexibility of the language model.

During specific implementation, a first prompt is generated, the first prompt is sent to the first language model, and at least one code obfuscation manner returned by the first language model is received.

The first prompt may include the first obfuscated code, the second obfuscated code, and information indicating extraction of the code obfuscation manner. By configuring the foregoing information in the first prompt, the first language model may extract the code obfuscation manner from the first obfuscated code and the second obfuscated code based on a prompting capability of the first prompt.

For example, the first prompt may be as follows:

“You are a professional code analysis expert, good at detecting obfuscation in code, and able to accurately analyze a code obfuscation manner and provide a clear obfuscation template.

When the user provides a piece of code, carefully check whether the code is obfuscated. If it is obfuscated, analyze a specific code obfuscation manner, describe each code obfuscation manner in detail, and give an example of the code obfuscation manner.

Code is as follows: {first obfuscated code}, {second obfuscated code}”

After the code obfuscation manner is extracted, the second language model is used to perform code obfuscation on the first unobfuscated code and the second unobfuscated code by using one or more code obfuscation manners, to obtain the first-type attack obfuscated code generated by the language model and the obfuscated code generated by the language model.

Similarly, the second language model may perform code obfuscation on the first unobfuscated code and the second unobfuscated code in a prompt learning-based manner. During specific implementation, generating a second prompt, sending the second prompt to the second language model, and receiving, from the second language model, the first-type attack obfuscated code, which is generated by the language model and has undergone code obfuscation, and the code-obfuscated obfuscated code generated by the language model.

The second prompt may include the at least one code obfuscation manner, the first unobfuscated code, the second unobfuscated code, and information used to indicate performing code obfuscation by using the code obfuscation manner. By configuring the foregoing information in the second prompt, the second language model may perform code obfuscation on the first unobfuscated code and the second unobfuscated code based on the prompting capability of the second prompt.

For example, the second prompt may be as follows:

“You are a professional code obfuscation expert, capable of accurately obfuscating input code according to a given code obfuscation manner, while ensuring that a function of the obfuscated code remains unchanged.

When the user inputs code and a code obfuscation manner, carefully analyze the code structure and the code obfuscation manner, and strictly obfuscate the code according to the code obfuscation manner, to ensure that the obfuscated code is completely consistent with the original code in terms of function.

The code obfuscation manner is as follows: {at least one code obfuscation manner}

Code is as follows: {first unobfuscated code}, {second unobfuscated code}”

For example, the first unobfuscated code is “<?php eval(@$_POST['pass']); ?>”, the code obfuscation manner is “the manner of using the bitwise operator to operate on the character string in the code”, and the first-type attack obfuscated code generated by the language model returned by the second language model is “<?php$var=‘e’\hat{ }‘E’; $var2=‘v’\hat{ }‘V’; $var3=‘a’\hat{ }‘A’; $var4=‘l’\hat{ }‘L’; $var5=‘(@’\hat{ }‘(@’; $var6=‘_POST’\hat{ }‘_POSt’; $var7=‘[\‘pass\’]’\hat{ }‘[\‘pass\’]’; $code=($var1.$var2.$var3.$var4). $var5.$var6.$var7; eval($code); ?>”.

In some possible implementations, the language model-generated code is generated by:
obtaining third unobfuscated code and fourth unobfuscated code, and using a third language model to rewrite the third unobfuscated code and the fourth unobfuscated code to obtain the language model-generated code.

The third unobfuscated code is unobfuscated code used to perform the first-type attack, and the second unobfuscated code is unobfuscated code irrelevant to the first-type attack.

In other words, the third language model is used to rewrite the manually written code to generate a large amount of code generated by the language model, thereby implementing data enhancement and improving the training effect. The third language model may be understood as a language model used to rewrite code. The third language model has a natural language processing capability, and may understand the meaning of a natural language and process different types of natural language tasks. For example, the third language model may be a deep learning model trained using text data.

Similarly, the third language model may rewrite the third unobfuscated code and the fourth unobfuscated code in a prompt learning-based manner. During specific implementation, a third prompt is generated, the third prompt is sent to the third language model, and the rewritten language model-generated code returned by the third language model is received.

The third prompt may include the third unobfuscated code, the fourth unobfuscated code, and information indicating optimization of the code. By configuring the foregoing information in the third prompt, the third language model may rewrite the third unobfuscated code and the fourth unobfuscated code based on a prompting capability of the third prompt, such that the rewritten code has the language model generation trace.

For example, the third prompt may be as follows:

“You are a code optimization master, capable of accurately analyzing and optimizing input code. You may provide high-quality solutions for either code specification issues or organization structure issues.

After receiving a piece of code, carefully check whether it complies with common programming specifications. If there are specification issues, point out the problems and provide specification code. If the code specification is okay, analyze whether the organization structure may be optimized, and adjust the organization structure of the code to make it clearer and more readable while keeping the code function unchanged.

Code is as follows: {third unobfuscated code}, {fourth unobfuscated code}”

In this way, a large amount of effective training data is generated for the first expert model, the second expert model, and the third expert model, to enrich the training dataset, accelerate the training process of the Mixture-of-Experts model, and improve the identification capability of the Mixture-of-Experts model for the first-type attack in a real environment. In addition, the Mixture-of-Experts model may quickly adapt to an emerging first-type attack, and optimize a detection means for an obfuscation-type first-type attack, to maintain an efficient detection capability.

Further, the Mixture-of-Experts model may further include a gating router. Similarly, because the gating router is configured to determine an expert model that needs to be activated for each token, during a training process of the gating router, a code sample used to perform the first-type attack (including manually written code used to perform the first-type attack and code generated by the language model and used to perform the first-type attack) and a code sample irrelevant to the first-type attack are used to train a parameter of the gating router.

The code detection method provided in the embodiments of the present application is described above in detail with reference to FIG. 1 to FIG. 3. With reference to the drawings, the following describes an apparatus and a device provided in the embodiments of the present application.

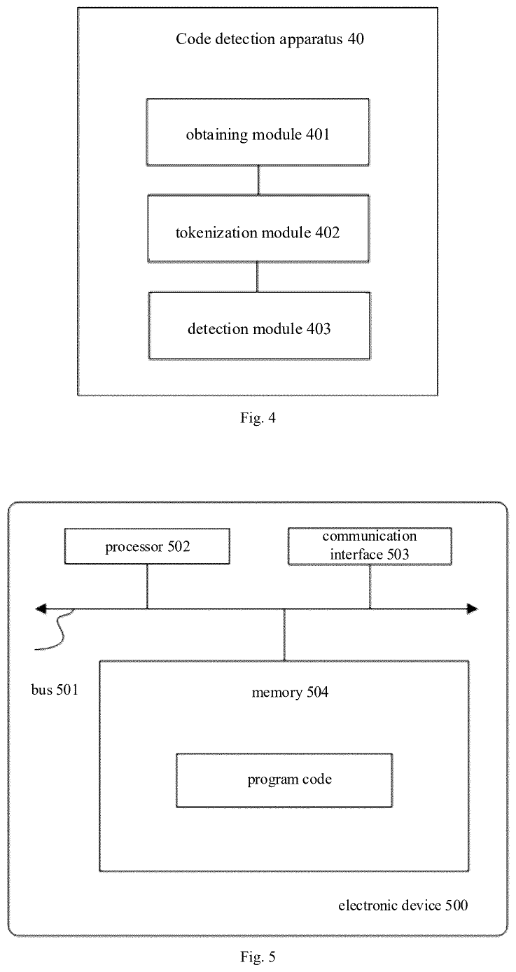

FIG. 4 is a schematic diagram of a structure of a code detection apparatus. The apparatus 40 includes:
an obtaining module 401 configured to obtain first code;
a tokenization module 402 configured to perform tokenization on the first code to obtain a plurality of tokens; and
a detection module 403 configured to input the plurality of tokens into a Mixture-of-Experts model, and receive a code detection result output by the Mixture-of-Experts model, where the Mixture-of-Experts model includes a first expert model configured to extract a feature related to a first-type attack, a second expert model configured to extract a feature related to obfuscated code, and a third expert model configured to extract a feature related to language model-generated code, the code detection result is determined based on one or more of the feature related to the first-type attack, the feature related to the obfuscated code, and the feature related to the language model-generated code, and the code detection result is used to represent whether the first code belongs to obfuscated code that is generated by a language model and used to perform the first-type attack.

In some possible implementations, the Mixture-of-Experts model further includes a gating router, and outputs of the gating router are respectively inputs of the first expert model, the second expert model, and the third expert model; and the detection module 403 is further configured to:
perform the following operation for each of the plurality of tokens: inputting the token into the gating router, such that the gating router determines an expert model activation probability of the token, sending the token to a target expert model corresponding to the expert model activation probability, obtaining a target sub-feature of the token that is returned by the target expert model, and wherein the target expert model is at least one selected from the group consisting of: the first expert model, the second expert model, and the third expert model; the target sub-feature is at least one selected from the group consisting of: the feature related to the first-type attack, the feature related to the obfuscated code, and the feature related to the language model-generated code; and
determine the code detection result based on the target sub-feature of each token.

In some possible implementations, the Mixture-of-Experts model further includes a feedforward neural network and a classifier, an input of the feedforward neural network is an output of the first expert model, an output of the second expert model, and an output of the third expert model, and an input of the classifier is an output of the feedforward neural network; and the detection module 403 is further configured to:
perform the following operation for the target sub-feature of each token: sending the target sub-feature of the token to the feedforward neural network, such that the feedforward neural network fuses, based on the expert model activation probability of the token, the target sub-feature of the token to obtain a target feature of the token; and
sending the target feature of each token to the classifier, to obtain the code detection result output by the classifier.

In some possible implementations, the apparatus 40 further includes a disposal module, and the disposal module is configured to:
generate a disposal suggestion for the first code in response to the code detection result representing that the first code belongs to the obfuscated code that is generated by the language model and used to perform the first-type attack, where the disposal suggestion includes at least one of the following: a code obfuscation manner of the first code, and code content generated by the language model in the first code.

In some possible implementations, the Mixture-of-Experts model is trained by:
obtaining a non-attack code sample and a first-type attack code sample, using the non-attack code sample as a negative sample and the first-type attack code sample as a positive sample, and training a first pre-trained model to obtain the first expert model;
obtaining an unobfuscated code sample and an obfuscated code sample, using the unobfuscated code sample as a negative sample and the obfuscated code sample as a positive sample, and training a second pre-trained model to obtain the second expert model; and
obtaining a manually written code sample and a code sample generated by a language model, using the manually written code sample as a negative sample and the code sample generated by a language model as a positive sample, and training a third pre-trained model to obtain the third expert model.

In some possible implementations, the first-type attack code sample includes at least one of the following: manually written first-type attack code and first-type attack obfuscated code generated by a language model; the obfuscated code sample includes at least one of the following: manually written obfuscated code and obfuscated code generated by a language model; and the language model-generated code sample includes at least one of the following: obfuscated code generated by the language model and code generated by the language model.

In some possible implementations, the first-type attack obfuscated code generated by the language model and the obfuscated code generated by the language model are generated by:
obtaining first obfuscated code, second obfuscated code, first unobfuscated code, and second unobfuscated code, where the first obfuscated code is obfuscated code used to perform a first-type attack, the second obfuscated code is obfuscated code irrelevant to the first-type attack, the first unobfuscated code is unobfuscated code used to perform the first-type attack, and the second unobfuscated code is unobfuscated code irrelevant to the first-type attack;
using a first language model to perform code obfuscation manner extraction on the first obfuscated code and the second obfuscated code to obtain at least one code obfuscation manner; and
using a second language model to perform code obfuscation on the first unobfuscated code and the second unobfuscated code based on the at least one code obfuscation manner, to obtain first-type attack obfuscated code generated by the language model and obfuscated code generated by the language model.

In some possible implementations, the code obfuscation manner includes at least one of the following:
a manner of using a bitwise operator to operate on a character string in the code;
a manner of concatenating or splitting a character string in the code;
a manner of using a random variable name in the code;
a manner of obfuscating an input parameter and an output parameter of a function call in the code; and
a manner of obfuscating a conditional judgment statement in the code.

In some possible implementations, the language model-generated code is generated by:
obtaining third unobfuscated code and fourth unobfuscated code, where the third unobfuscated code is unobfuscated code used to perform a first-type attack, and the fourth unobfuscated code is unobfuscated code irrelevant to the first-type attack; and
using a third language model to rewrite the third unobfuscated code and the fourth unobfuscated code to obtain language model-generated code.

The code detection apparatus 40 according to the embodiment of the present application may correspond to the method described in the embodiments of the present application. The foregoing and other operations and/or functions of the modules/units of the code detection apparatus 40 are respectively intended to implement corresponding procedures of the methods in the embodiment shown in FIG. 1. For the sake of brevity, details are not described herein again.

An embodiment of the present application further provides an electronic device. The electronic device is further configured to implement the function of the code detection apparatus 40 in the embodiment shown in FIG. 4.

FIG. 5 is a schematic diagram of a structure of an electronic device 500. As shown in FIG. 5, the electronic device 500 includes a bus 501, a processor 502, a communications interface 503, and a memory 504. The processor 502, the memory 504, and the communications interface 503 communicate with each other through the bus 501.

The bus 501 may be a peripheral component interconnect (PCI) bus, an extended industry standard architecture (EISA) bus, or the like. The bus may be classified into an address bus, a data bus, a control bus, and the like. For ease of representation, only one thick line is used to represent the bus in FIG. 5, but this does not mean that there is only one bus or one type of bus.

The processor 502 may be any one or more of a central processing unit (CPU), a graphics processing unit (GPU), a microprocessor (MP), a digital signal processor (DSP), and the like.

The communications interface 503 is configured to communicate with an external device. For example, the communications interface 503 may be configured to communicate with a terminal.

The memory 504 may include a volatile memory, for example, a random access memory (RAM). The memory 504 may further include a non-volatile memory, for example, a read-only memory (ROM), a flash memory, a hard disk drive (HDD), or a solid state drive (SSD).

The memory 504 stores executable code, and the processor 502 executes the executable code to perform the foregoing code detection method.

Specifically, when the embodiment shown in FIG. 4 is implemented, and the modules or units of the code detection apparatus 40 described in the embodiment of FIG. 4 are implemented in software, the software or program code required to perform the functions of the modules/units in FIG. 4 may be partially or entirely stored in the memory 504. The processor 502 executes the program code corresponding to the units stored in the memory 504, to perform the foregoing code detection method.

An embodiment of the present application further provides a computer-readable storage medium. The computer-readable storage medium may be any usable medium that may be stored by a computing device, or a data storage device, such as a data center, that includes one or more usable media. The usable medium may be a magnetic medium (for example, a floppy disk, a hard disk, or a magnetic tape), an optical medium (for example, a DVD), a semiconductor medium (for example, a solid state disk), or the like. The computer-readable storage medium includes instructions, and the instructions instruct a computing device to perform the foregoing code detection method applied to the code detection apparatus 40.

An embodiment of the present application further provides a computer program product, where the computer program product includes one or more computer instructions. When the computer instructions are loaded and executed on a computing device, the procedure or functions according to the embodiments of the present application are all or partially generated.

The computer instructions may be stored in a computer-readable storage medium or may be transmitted from a computer-readable storage medium to another computer-readable storage medium. For example, the computer instructions may be transmitted from a website, computer, or data center to another website, computer, or data center in a wired (for example, a coaxial cable, an optical fiber, or a digital subscriber line (DSL)) or wireless (for example, infrared, radio, or microwave) manner.

When the computer program product is executed by a computer, the computer performs any one of the foregoing code detection methods. The computer program product may be a software installation package, and when any one of the foregoing code detection methods needs to be used, the computer program product may be downloaded and executed on the computer.

The flowchart and block diagram in the drawings illustrate the possibly implemented architectures, functions, and operations of the system, the method, and the computer program product according to the embodiments of the present application. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present application may be implemented in software or hardware. The name of a unit/module does not constitute a limitation on the unit itself in some cases.

The functions described above herein may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), and the like.

In the context of the embodiments of the present application, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include but be not limited to an electronic, magnetic, optical, electromagnetic, infrared, or semiconductor system, apparatus, or device, or any suitable combination thereof. More specific examples of the machine-readable storage medium may include an electrical connection on the basis of one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

It should be noted that the embodiments in the specification are described in a progressive manner, each embodiment focuses on the differences from other embodiments, and the same and similar parts between the embodiments may be referred to each other. For a system or apparatus disclosed in an embodiment, since it corresponds to the method disclosed in the embodiment, the description is relatively simple, and reference may be made to the description of the method for relevant parts.

It should be understood that in the present application, “at least one (item)” means one or more, and “a plurality of” means two or more. “And/or” describes an association relationship between associated objects, and represents that three relationships may exist. For example, “A and/or B” may represent the following three cases: Only A exists, only B exists, and both A and B exist, where A and B may be singular or plural. The character “/” generally indicates an “or” relationship between the associated objects. At least one of the following items (pieces)” or a similar expression thereof indicates any combination of these items, including a single item (piece) or any combination of a plurality of items (pieces). For example, at least one of a, b, or c may represent: a, b, c, “a and b”, “a and c”, “b and c”, or “a, b, and c”, where a, b, and c may be singular or plural.

It should also be noted that in this paper, a relational term such as “first” and “second” is merely used to distinguish one entity or operation from another entity or operation, and does not necessarily require or imply any actual relationship or order between these entities or operations. Furthermore, the terms “include”, “include”, or any other variant thereof are intended to cover non-exclusive inclusion, such that a process, method, item, or device that includes a list of elements includes not only those elements, but also other elements not explicitly listed or elements inherent to such process, method, item, or device. Without further restrictions, an element defined by the phrase “includes a” does not exclude that there are other identical elements in the process, method, item, or device that includes the element.

Steps of a method or an algorithm described in conjunction with the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or a storage medium of any other form known in the art.

The foregoing descriptions of the disclosed embodiments enable those skilled in the art to implement or use the present application. Various modifications to these embodiments will be obvious to those skilled in the art, and the generic principles defined herein may be implemented in other embodiments without departing from the spirit or scope of the present application. Therefore, the present application is not limited to the embodiments shown herein, but is to be accorded the widest scope consistent with the principles and novel features disclosed herein.

1. A code detection method, comprising:
obtaining first code;
performing tokenization on the first code to obtain a plurality of tokens; and
inputting the plurality of tokens into a Mixture-of-Experts model, and receiving a code detection result output by the Mixture-of-Experts model,
wherein the Mixture-of-Experts model comprises a first expert model configured to extract a feature related to a first-type attack, a second expert model configured to extract a feature related to obfuscated code, and a third expert model configured to extract a feature related to language model-generated code, the code detection result is determined based on at least one consisting of: the feature related to the first-type attack, the feature related to the obfuscated code, and the feature related to the language model-generated code, and the code detection result is used to represent whether the first code belongs to obfuscated code that is generated by a language model and used to perform the first-type attack.

2. The method of claim 1, wherein the Mixture-of-Experts model further comprises a gating router, and outputs of the gating router are respectively inputs of the first expert model, the second expert model, and the third expert model; and
the inputting the plurality of tokens into a Mixture-of-Experts model, and receiving a code detection result output by the Mixture-of-Experts model, comprises:
performing following operations for each token of the plurality of tokens:
inputting the token into the gating router, such that the gating router determines an expert model activation probability of the token,
sending the token to a target expert model corresponding to the expert model activation probability,
obtaining a target sub-feature of the token that is returned by the target expert model, and
wherein the target expert model is at least one selected from the group consisting of: the first expert model, the second expert model, and the third expert model; the target sub-feature is at least one selected from the group consisting of: the feature related to the first-type attack, the feature related to the obfuscated code, and the feature related to the language model-generated code; and
determining the code detection result based on the target sub-feature of each token.

3. The method of claim 2, wherein the Mixture-of-Experts model further comprises a feedforward neural network and a classifier, an input of the feedforward neural network is an output of the first expert model, an output of the second expert model, and an output of the third expert model, and an input of the classifier is an output of the feedforward neural network; and
the determining the code detection result based on the target sub-feature of each token, comprises:
performing following operations for the target sub-feature of each token:
sending the target sub-feature of the token to the feedforward neural network, such that the feedforward neural network fuses, based on the expert model activation probability of the token, the target sub-feature of the token to obtain a target feature of the token; and
sending the target feature of each token to the classifier, to obtain the code detection result output by the classifier.

4. The method of claim 1, further comprising:
generating a disposal suggestion for the first code in response to the code detection result representing that the first code belongs to the obfuscated code that is generated by the language model and used to perform the first-type attack, wherein the disposal suggestion comprises at least one of following: a code obfuscation manner of the first code, and code content generated by the language model in the first code.

5. The method of claim 1, wherein the Mixture-of-Experts model is trained by:
obtaining a non-attack code sample and a first-type attack code sample, using the non-attack code sample as a negative sample and the first-type attack code sample as a positive sample, and training a first pre-trained model to obtain the first expert model;
obtaining an unobfuscated code sample and an obfuscated code sample, using the unobfuscated code sample as a negative sample and the obfuscated code sample as a positive sample, and training a second pre-trained model to obtain the second expert model; and
obtaining a manually written code sample and a code sample generated by a language model, using the manually written code sample as a negative sample and the code sample generated by a language model as a positive sample, and training a third pre-trained model to obtain the third expert model.

6. The method of claim 5, wherein the first-type attack code sample comprises at least one selected from the group consisting of: manually written first-type attack code and first-type attack obfuscated code generated by a language model;
the obfuscated code sample comprises at least one selected from the group consisting of: manually written obfuscated code and obfuscated code generated by a language model; and
the language model-generated code sample comprises selected from the group consisting of: obfuscated code generated by a language model and code generated by a language model.

7. The method of claim 6, wherein the first-type attack obfuscated code generated by the language model and the obfuscated code generated by the language model are generated by:
obtaining first obfuscated code, second obfuscated code, first unobfuscated code, and second unobfuscated code, wherein the first obfuscated code is obfuscated code used to perform first-type attack, the second obfuscated code is obfuscated code irrelevant to the first-type attack, the first unobfuscated code is unobfuscated code used to perform the first-type attack, and the second unobfuscated code is unobfuscated code irrelevant to the first-type attack;
using a first language model to perform code obfuscation manner extraction on the first obfuscated code and the second obfuscated code to obtain at least one code obfuscation manner; and
using a second language model to perform code obfuscation on the first unobfuscated code and the second unobfuscated code based on the at least one code obfuscation manner, to obtain first-type attack obfuscated code generated by the language model and obfuscated code generated by the language model.

8. The method of claim 7, characterized in that the code obfuscation manner comprises at least selected from the group consisting of:
a manner of using a bitwise operator to operate on a character string in code;
a manner of concatenating or splitting a character string in the code;
a manner of using a random variable name in the code;
a manner of obfuscating an input parameter and an output parameter of a function call in the code; and
a manner of obfuscating a conditional judgment statement in the code.

9. The method of claim 6, wherein the language model-generated code is generated by:
obtaining third unobfuscated code and fourth unobfuscated code, wherein the third unobfuscated code is unobfuscated code used to perform the first-type attack, and the fourth unobfuscated code is unobfuscated code irrelevant to the first-type attack; and
using a third language model to rewrite the third unobfuscated code and the fourth unobfuscated code to obtain language model-generated code.

10. An electronic device, characterized in that the electronic device comprises a processor and a memory; and
the processor is configured to execute instructions stored in the memory, to enable the electronic device to perform a code detection method,
wherein the code detection method comprises:
obtaining first code;
performing tokenization on the first code to obtain a plurality of tokens; and
inputting the plurality of tokens into a Mixture-of-Experts model, and receiving a code detection result output by the Mixture-of-Experts model,
wherein the Mixture-of-Experts model comprises a first expert model configured to extract a feature related to a first-type attack, a second expert model configured to extract a feature related to obfuscated code, and a third expert model configured to extract a feature related to language model-generated code, the code detection result is determined based on at least one consisting of: the feature related to the first-type attack, the feature related to the obfuscated code, and the feature related to the language model-generated code, and the code detection result is used to represent whether the first code belongs to obfuscated code that is generated by a language model and used to perform the first-type attack.

11. The electronic device of claim 10, wherein the Mixture-of-Experts model further comprises a gating router, and outputs of the gating router are respectively inputs of the first expert model, the second expert model, and the third expert model; and
the inputting the plurality of tokens into a Mixture-of-Experts model, and receiving a code detection result output by the Mixture-of-Experts model, comprises:
performing following operations for each token of the plurality of tokens:
inputting the token into the gating router, such that the gating router determines an expert model activation probability of the token,
sending the token to a target expert model corresponding to the expert model activation probability,
obtaining a target sub-feature of the token that is returned by the target expert model, and
wherein the target expert model is at least one selected from the group consisting of: the first expert model, the second expert model, and the third expert model; the target sub-feature is at least one selected from the group consisting of: the feature related to the first-type attack, the feature related to the obfuscated code, and the feature related to the language model-generated code; and
determining the code detection result based on the target sub-feature of each token.

12. The electronic device of claim 11, wherein the Mixture-of-Experts model further comprises a feedforward neural network and a classifier, an input of the feedforward neural network is an output of the first expert model, an output of the second expert model, and an output of the third expert model, and an input of the classifier is an output of the feedforward neural network; and
the determining the code detection result based on the target sub-feature of each token, comprises:
performing following operations for the target sub-feature of each token:
sending the target sub-feature of the token to the feedforward neural network, such that the feedforward neural network fuses, based on the expert model activation probability of the token, the target sub-feature of the token to obtain a target feature of the token; and
sending the target feature of each token to the classifier, to obtain the code detection result output by the classifier.

13. The electronic device of claim 10, further comprising:
generating a disposal suggestion for the first code in response to the code detection result representing that the first code belongs to the obfuscated code that is generated by the language model and used to perform the first-type attack, wherein the disposal suggestion comprises at least one of following: a code obfuscation manner of the first code, and code content generated by the language model in the first code.

14. The electronic device of claim 10, wherein the Mixture-of-Experts model is trained by:
obtaining a non-attack code sample and a first-type attack code sample, using the non-attack code sample as a negative sample and the first-type attack code sample as a positive sample, and training a first pre-trained model to obtain the first expert model;
obtaining an unobfuscated code sample and an obfuscated code sample, using the unobfuscated code sample as a negative sample and the obfuscated code sample as a positive sample, and training a second pre-trained model to obtain the second expert model; and
obtaining a manually written code sample and a code sample generated by a language model, using the manually written code sample as a negative sample and the code sample generated by a language model as a positive sample, and training a third pre-trained model to obtain the third expert model.

15. The electronic device of claim 14, wherein the first-type attack code sample comprises at least one selected from the group consisting of: manually written first-type attack code and first-type attack obfuscated code generated by a language model;
the obfuscated code sample comprises at least one selected from the group consisting of: manually written obfuscated code and obfuscated code generated by a language model; and
the language model-generated code sample comprises selected from the group consisting of: obfuscated code generated by a language model and code generated by a language model.

16. The electronic device of claim 15, wherein the first-type attack obfuscated code generated by the language model and the obfuscated code generated by the language model are generated by:
obtaining first obfuscated code, second obfuscated code, first unobfuscated code, and second unobfuscated code, wherein the first obfuscated code is obfuscated code used to perform first-type attack, the second obfuscated code is obfuscated code irrelevant to the first-type attack, the first unobfuscated code is unobfuscated code used to perform the first-type attack, and the second unobfuscated code is unobfuscated code irrelevant to the first-type attack;
using a first language model to perform code obfuscation manner extraction on the first obfuscated code and the second obfuscated code to obtain at least one code obfuscation manner; and
using a second language model to perform code obfuscation on the first unobfuscated code and the second unobfuscated code based on the at least one code obfuscation manner, to obtain first-type attack obfuscated code generated by the language model and obfuscated code generated by the language model.

17. The electronic device of claim 16, characterized in that the code obfuscation manner comprises at least selected from the group consisting of:
a manner of using a bitwise operator to operate on a character string in code;
a manner of concatenating or splitting a character string in the code;
a manner of using a random variable name in the code;
a manner of obfuscating an input parameter and an output parameter of a function call in the code; and
a manner of obfuscating a conditional judgment statement in the code.

18. The electronic device of claim 15, wherein the language model-generated code is generated by:
obtaining third unobfuscated code and fourth unobfuscated code, wherein the third unobfuscated code is unobfuscated code used to perform the first-type attack, and the fourth unobfuscated code is unobfuscated code irrelevant to the first-type attack; and
using a third language model to rewrite the third unobfuscated code and the fourth unobfuscated code to obtain language model-generated code.

19. A non-transitory computer-readable storage medium, characterized by comprising instructions, wherein the instructions instruct an electronic device to perform a code detection method,
wherein the code detection method comprises:
obtaining first code;
performing tokenization on the first code to obtain a plurality of tokens; and
inputting the plurality of tokens into a Mixture-of-Experts model, and receiving a code detection result output by the Mixture-of-Experts model,
wherein the Mixture-of-Experts model comprises a first expert model configured to extract a feature related to a first-type attack, a second expert model configured to extract a feature related to obfuscated code, and a third expert model configured to extract a feature related to language model-generated code, the code detection result is determined based on at least one consisting of: the feature related to the first-type attack, the feature related to the obfuscated code, and the feature related to the language model-generated code, and the code detection result is used to represent whether the first code belongs to obfuscated code that is generated by a language model and used to perform the first-type attack.

20. The non-transitory computer-readable storage medium of claim 19, wherein the Mixture-of-Experts model further comprises a gating router, and outputs of the gating router are respectively inputs of the first expert model, the second expert model, and the third expert model; and
the inputting the plurality of tokens into a Mixture-of-Experts model, and receiving a code detection result output by the Mixture-of-Experts model, comprises:
performing following operations for each token of the plurality of tokens:
inputting the token into the gating router, such that the gating router determines an expert model activation probability of the token,
sending the token to a target expert model corresponding to the expert model activation probability,
obtaining a target sub-feature of the token that is returned by the target expert model, and
wherein the target expert model is at least one selected from the group consisting of: the first expert model, the second expert model, and the third expert model; the target sub-feature is at least one selected from the group consisting of: the feature related to the first-type attack, the feature related to the obfuscated code, and the feature related to the language model-generated code; and
determining the code detection result based on the target sub-feature of each token.
